(19) United States
(12) Patent Application Publication
(10) Pub. No.: US 2025/0237497 A1
(43) Pub. Date: Jul. 24, 2025

(54) CORRECTION DEVICE

(71) Applicant: SENSWORK GMBH, Burghausen (DE)

(72) Inventors: Andreas KÖNIG, Mittelstetten (DE); Roman RIEGER, Teisendorf (DE); Rainer OBERGRUßBERGER, Pleiskirchen (DE)

(73) Assignee: SENSWORK GMBH, Burghausen (DE)

(21) Appl. No.: 19/023,586

(22) Filed: Jan. 16, 2025

(30) Foreign Application Priority Data
Jan. 22, 2024 (DE) 10 2024 101 786.4

(51) Int. Cl. G01B 11/24; B25J 19/02

(52) U.S. Cl. CPC G01B 11/24; B25J 19/022

(57) ABSTRACT

The invention relates to a correction device for a movable data acquisition device for acquiring geometric data of an object, comprising at least one reference geometry for at least partial disposition within a scanning range of the data acquisition device, and an evaluation device for correcting the geometric data on the basis of reference geometric data of the reference geometry acquired by the data acquisition device.

### FIELD OF INVENTION

The invention relates to a correction device for a movable data acquisition device for acquiring geometric data of an object.

### BACKGROUND

Moving data acquisition devices can, for example, have a scanner mounted on a robot arm.

Previous correction devices have been used to calibrate the scanner once.

If the data acquisition device moves, however, interference data may keep occurring, for example due to vibrations of the robot arm and/or so-called stick-slip effects.

Previous correction devices do not correct such interference data.

### BRIEF SUMMARY OF THE INVENTION

It is therefore an object of the invention to create a correction device, a data acquisition device, a system and a method in which interference data arising from a movement of the data acquisition device are corrected.

This object is solved by the subject matter and the method of the independent claims.

According to the invention, the correction device is provided for a movable or moving data acquisition device for acquiring geometric data of an object, e.g. a test specimen, or is configured and/or may be used for this purpose.

The data acquisition device may move, for example, to scan at least one large object and/or to scan at least one object from different sides.

For example, it is also possible to scan several objects.

Preferably, the data can be acquired acoustically, e.g. by means of ultrasound, and/or optically, e.g. by means of light waves. In this connection, at least one ultrasonic sensor, laser, scanner, lidar and/or camera system may be used, for example.

Data may be acquired, for example, in the visible and/or non-visible range.

Preferably, the 3D structure of an object may be acquired.

The correction device comprises at least one reference geometry disposed at least partially within a scanning range of the data acquisition device.

The reference geometry is disposed at least partially or completely in the scanning range, e.g. the field of view, of the data acquisition device. At least part of the reference geometry is therefore always scanned-preferably together with the object.

The shape of the reference geometry is preferably arbitrary.

For example, the reference geometry may be configured as a reference rail.

The material of the reference geometry is preferably arbitrary. For example, the reference geometry may comprise or consist of a plastic, metal, wood and/or stone material, e.g. granite.

The reference geometry may, for example, be placed next to the object or an object holder on which the object is located. For example, the reference geometry may be placed next to the object and/or fixed next to the object. For example, the reference geometry may be firmly attached to the object holder.

The correction device comprises an evaluation device for correcting the geometric data on the basis of reference geometric data of the reference geometry acquired by the data acquisition device.

The evaluation device may, for example, comprise or consist of a computing unit, e.g. a computer.

During operation, the data acquisition device acquires both the geometric data of the object and the reference geometric data of the reference geometry, preferably continuously.

The evaluation device may preferably evaluate the geometric data and the reference geometric data. As the shape of the reference geometry is known, interference data and/or offsets arising from the movement of the data acquisition device can be determined, equalized and/or eliminated and the geometric data corrected accordingly.

This correction is preferably carried out during data acquisition, with a time delay and/or downstream. The acquired geometric data are preferably always corrected.

Further embodiments of the invention may also be found in the dependent claims, the description and the accompanying drawings.

According to one embodiment, the reference geometry is disposed in an edge region of the scanning range.

The acquisition of the geometric data of the object is therefore not affected by the reference geometry.

According to a further embodiment, the reference geometry is adapted to the shape of the object.

Preferably, the reference geometry is modeled on the basic shape of the object.

For example, the reference geometry of a curved object may also be curved.

The more closely the shape of the reference geometry matches the shape of the object, the more accurate the correction will be, for example.

According to a further embodiment, the reference geometry is linear or curved.

For example, a circular reference geometry is conceivable.

According to a further embodiment, at least or exactly two reference geometries are provided.

Preferably, the reference geometries may be disposed on opposite sides of the object, e.g. above and below or left and right.

The reference geometries may, for example, be of the same design. Alternatively, the shape of the reference geometries may differ, for example. This is advantageous, for example, if the shape of the object differs on different sides.

The invention relates to a data acquisition device for acquiring geometric data of an object and reference geometric data of a reference geometry with an inventive correction device.

According to one embodiment, the data acquisition device comprises a scanner.

The scanner may preferably be a laser triangulation scanner. Other, e.g. acoustic and/or optical, detection devices are also conceivable in principle.

The data acquisition device may have an evaluation device, i.e. the evaluation device may be a component of the data acquisition device.

The evaluation device may be integrated into the scanner, for example.

According to a further embodiment, the data acquisition device comprises a drive device, preferably a robot.

For example, the scanner may be mounted on a robot arm. This enables extremely versatile use.

In principle, other drive devices, e.g. lifting platforms, rail systems and/or cranes, are also conceivable.

The invention relates to a system with an inventive data acquisition device and an object.

The object may form part of the system.

Several objects, e.g. two, three, four, five or more, may also be provided.

Finally, the invention relates to a method for correcting geometric data of an object that are acquired by a movable data acquisition device with the aid of an inventive correction device, an inventive data acquisition device and/or an inventive system.

In this connection, the data acquisition device acquires reference geometric data of at least one reference geometry.

The evaluation device corrects the geometric data using the reference geometric data.

As the expected surface data of the reference geometries are known in advance or are acquired in advance-several times, if necessary—the interference frequencies and/or offsets in the data portion of the object can be removed.

Preferably, the reference geometric data and the geometric data are acquired continuously together during operation and not just once for the purpose of calibration.

All embodiments and components of the devices described herein are preferably configured to be operated, e.g. by means of a control device, according to the method described herein. Furthermore, all embodiments of the devices described herein and all embodiments of the method described herein may be combined with each other, preferably also independently of the specific embodiment in the context of which they are mentioned.

### BRIEF DESCRIPTION OF THE DRAWINGS

The invention is described below by way of example with reference to the drawings. These show in:

FIG. 1: A perspective view of an embodiment of the inventive correction device, and

FIG. 2: A profile section of a scanned surface contour.

### DETAILED DESCRIPTION

First of all, it should be noted that the embodiments shown are purely exemplary in nature. Thus, individual features may be realized not only in the combination shown, but also alone or in other technically meaningful combinations. For example, the features of one embodiment may be arbitrarily combined with features of another embodiment. Preferably, the number of reference geometries or objects and/or their shape or size may vary. Furthermore, an alternative drive device may be provided instead of a robot.

Where a drawing contains a reference symbol that is not explained in the directly associated description text, reference is made to the corresponding previous or subsequent explanations in the description of the drawings. The same reference symbols are used for identical or comparable components in the drawings and are not explained again.

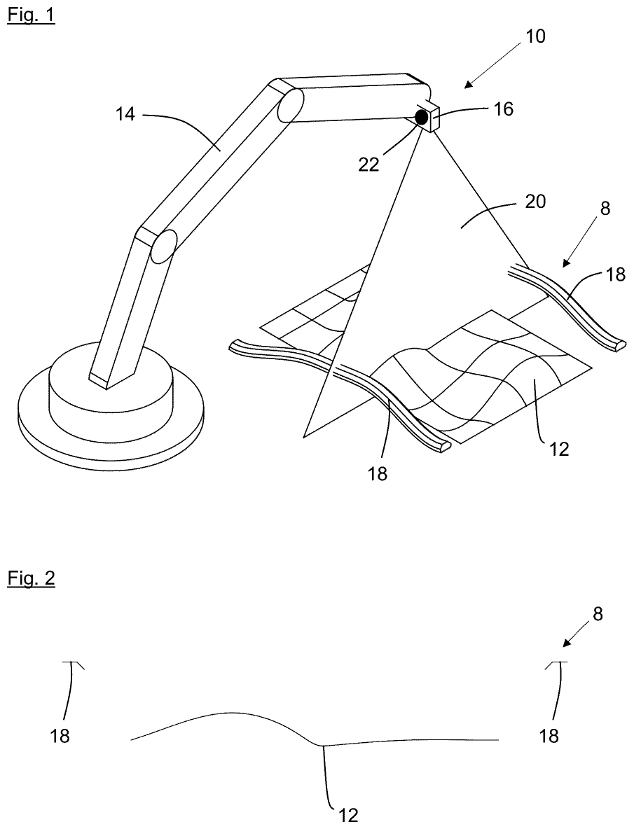

FIG. 1 shows a correction device 8 for a movable data acquisition device 10 for acquiring geometric data of an object 12.

The data acquisition device 10 comprises a drive device 14 configured as a robot and a scanner 16, e.g. a laser triangulation scanner, attached to the robot 14.

The correction device 8 has two reference geometries 18, which are disposed within a scanning range 20 of the data acquisition device 10.

The reference geometries 18 are disposed on opposite sides of the object 12 and each has a shape in space.

Furthermore, the correction device 8 has an evaluation device 22 for correcting the geometric data. The geometric data are corrected on the basis of reference geometric data of the reference geometries 18, which are acquired by the data acquisition device 10.

FIG. 2 shows a profile section of a scanned surface contour of the object 12, with the two reference geometries 18 on the left and right sides.

### LIST OF REFERENCE SYMBOLS

8 Correction device
10 Data acquisition device
12 Object
14 Robot, drive device
16 Scanner
18 Reference geometries
20 Scanning range
22 Evaluation device

1. Correction device (8) for a movable data acquisition device (10) for acquiring geometric data of an object (12), comprising
at least one reference geometry (18) for at least partial disposition within a scanning range (20) of the data acquisition device (10), and
an evaluation device (22) for correcting the geometric data on the basis of reference geometric data of the reference geometry (18) acquired by the data acquisition device (10).

2. Correction device (8) according to claim 1,
characterized in that
the reference geometry (18) is disposed in an edge region of the scanning range (20).

3. Correction device (8) according to claim 1,
characterized in that
the reference geometry (18) is adapted to the shape of the object (12).

4. Correction device (8) according to claim 1,
characterized in that
the reference geometry (18) is linear.

5. Correction device (8) according to claim 1,
characterized in that
the reference geometry (18) is curved.

6. Correction device (8) according to claim 1,
characterized in that
at least two reference geometries (18) are provided.

7. Correction device (8) according to claim 1,
characterized in that
exactly two reference geometries (18) are provided on opposite sides of the object (12).

8. Data acquisition device for acquiring geometric data of an object (12) and reference geometric data of a reference geometry (18), comprising a correction device (8), said correction device (8) comprising
at least one reference geometry (18) for at least partial disposition within a scanning range (20) of the data acquisition device (10), and
an evaluation device (22) for correcting the geometric data on the basis of reference geometric data of the reference geometry (18) acquired by the data acquisition device (10).

9. Data acquisition device according to claim 8,
characterized in that
the data acquisition device (10) comprises a scanner (16).

10. Data acquisition device according to claim 8,
characterized in that
the data acquisition device (10) comprises a laser triangulation scanner.

11. Data acquisition device according to claim 8,
characterized in that
the data acquisition device (10) comprises a drive device (14).

12. Data acquisition device according to claim 8,
characterized in that
the data acquisition device (10) comprises a drive device (14), which is configured as a robot.

13. Method for correcting geometric data of an object (12) that are acquired by
a movable data acquisition device (10), comprising a correction device (8), said correction device (8) comprising at least one reference geometry (18) for at least partial disposition within a scanning range (20) of the data acquisition device (10), and an evaluation device (22) for correcting the geometric data on the basis of reference geometric data of the reference geometry (18) acquired by the data acquisition device (10), wherein
the data acquisition device (10) acquires reference geometric data of at least one reference geometry (18), and
the evaluation device (22) corrects the geometric data using the reference geometric data.
